(19) United States
(12) Patent Application Publication
(10) Pub. No.: US 2024/0309216 A1
(43) Pub. Date: Sep. 19, 2024

(54) Method for Agglomerating Pigments and Powders

(71) Applicants: Christopher Scott Bohach, Atlanta, GA (US); William Louis Bohach, Savannah, GA (US); Tracey Bohach Cabrey, Brookhaven, GA (US)

(72) Inventors: Christopher Scott Bohach, Atlanta, GA (US); William Louis Bohach, Savannah, GA (US); Tracey Bohach Cabrey, Brookhaven, GA (US)

(21) Appl. No.: 18/183,951

(22) Filed: Mar. 15, 2023

(51) Int. Cl. C09C 3/04; C09C 1/24; C09C 1/36; C09C 3/00; C09C 3/06; C09C 3/08; C09C 3/12

(52) U.S. Cl. CPC C09C 3/045; C09C 1/24; C09C 1/3638; C09C 1/3661; C09C 1/3669; C09C 1/3684; C09C 3/006; C09C 3/063; C09C 3/08; C09C 3/12; C01P 2004/32; C01P 2004/50; C01P 2004/61

(57) ABSTRACT

Titanium Dioxide and other pigments or powders processed by this present process are smoothly discharging, low dusting, agglomerated, compaction resistant, extremely friable, and fully dispersible, and the process for the production of smoothly discharging pigment or powder consists of gently blending in the presence of an air flow and an electrostatic charge where said pigment or powder is agglomerated with or without a treated or non-treated seed particle of the same or similar pigment whereas said pigment or powder in accordance with the invention yields a composition of substantially spherical particulate that has a pseudo-particle size of 0.1-5.0 mm in the form of smoothly discharging, low dusting, non-sticky, agglomerated, compaction resistant pigment or powder, in which said pigment or powder particles are 80% -99.9% by weight, pigment, and in which the pigments or powders are compatible with inks, paints and plastics, and can be readily dispersed and incorporated into the same.

### CROSS-REFERENCE TO RELATED APPLICATION

The present application claims the benefit of U.S. Provisional Application No. 63/372,426 filed: Mar. 14, 2022, which is hereby incorporated by reference in its entirety for all purposes.

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

### Field of the Invention

The present invention relates to a process and equipment for manufacturing, smoothly-discharging, low-dusting, high bulk density, easily dispersible titanium dioxide and other pigments and cohesive powders that will resist compaction, rat holing, bridging, aging, lumping and caking, in which the pigment or powder has been subjected to micronizing or jet milling, sand milling, hammer milling, ground up or the like for use in foodstuffs, cosmetics, detergents, paint and plastics, inks and elastomers.

### Description of the Prior Art

Titanium dioxide pigment, iron oxides pigments, pearlescent pigments, organic pigments, powders, and other metal oxide pigments, are used in the cosmetics, detergents, paint, plastics, and other industries where pigments or powders are added to color and/or opacify the desired application and usually through intensive mixing. Some essential properties for the pigments are the dispersibility of the pigment throughout the application system, the ease of bulk material handling, metering and the amount of dusting.

Titanium Dioxide and other pigments normally produced are in the form of a finely divided powder. The powders are usually jet-milled, sand milled, hammer milled or roller milled as a finishing step in their production. Milling contributes to dispersibility and gloss, but milled pigments exhibit poor dry flow characteristics and are dusty. Such pigments all have the great disadvantage of producing dust. During their use, costly measures (for example of a workplace safety, ecological or quality assurance nature) are necessary, and valuable material is lost.

The ease of handling or lack thereof, takes into consideration difficulties associated with storing, transportation and mixing of the pigments in the manufacturing and processing system. It should be noted that the goals of achieving good dispersibility and good stability are usually contrary to one another.

In U.S. Pat. No. 4,285,994, the invention comprises a free-flowing nucleated pigment 50% by weight or more, in a spherical particulate of spray-chilled wax composition that has a coating and is partially absorbed into a pigment.

U.S. Pat. No. 4,375,520. This patent teaches the production of dustless particles, including pigments, by treatment of the particles with a solid low-molecular weight polymer and a liquid polymer substance such as epoxidized soybean oil at temperatures above the melting point of the polymer.

Problems repeatedly experienced in handling large quantities of powders are caking, rat holing, bridging, or aging in compressed storage and clogging with a loss of pigment flow when in feed bins. The stability of pigment granules is necessary for good storage and transporting, thus averting aging, or the clumping of pigment into large agglomerates when in storage subjected to heat, humidity and pressure. Combined with the problems associated with dust from finely divided powders it is frequently the case that pigment compositions are preferred in pellet particle or granular form.

U.S. Pat. No. 5,199,986 also discloses a process wherein previously spray-dried inorganic pigment granules are coated with water and solutions of salts of boron, aluminum, silicon, titanium, zinc, brass, or tin, to improve processing and reduce dust production

U.S. Pat. No. 5,604,279 shows that a colorant composition comprising at least one colorant very finely dispersed in a base material which is solid at room temperature is suitable for producing master batches and. provides the way to dust-free colorant compositions

Dispersibility is a measure of the ease with which the powder or pigment particles can be uniformly and intimately mixed in a system. Poor dispersion of particles can cause large agglomerates that may result in lumps, surface imperfections, color streaks, non-uniform coloration, or incomplete color development within the product. A further problem exists for pelletized or granular powder or pigment in that the amount of energy expended to disperse those types is exceptionally high and time consuming. Surface treatment of pigments to achieve improved performance characteristics such as dispersion in coatings and plastic compositions, and may help in dry flow, is known in the art as is shown in the following patents:

U.S. Pat. No. 3,925,095 teaches that treating of inorganic pigments or fillers with hydroxyalkylated alkylene diamine dispersing agent will help flowability and dispersibility in many applications.

In U.S. Pat. No. 4,056,402, shows that aqueous slurries of inorganic or organic pigments are milled in the presence of a nonionic, polyether alcohol dispersing agent and nonionic cellulose ether to improve dispersibility and reduce dusting.

U.S. Pat. No. 4,310,483 demonstrates a process for producing a granulate of fusible additives and pigments for plastics by thermal tumbling granulation, that comprises mixing the additive in powder form with an additive that softens between 30 degree C. and 200 degree C. and which have a particle size of 0.1-2.0 mm.

U.S. Pat. No. 4,464,203 discloses the treatment of inorganic or organic pigments with an amine and ethylene oxide block copolymer surfactant to improve pigment dispersibility and other properties in many applications.

Also known in the art is the absorption of waxes, aqueous solutions, polymers, and other oils, fats, or surfactants to help form free flowing granules.

U.S. Pat. No. 4,127,421 discloses the aqueous treatment of a lead chromate-containing pigment with a friable hydrocarbon resin and a cationic surfactant will produce free flowing, non-dusting granules.

U.S. Pat. No. 4,762,523 discloses coating a moist pigment with a polyester surfactant, then adding mineral oil or wax to the pigment and applying high shear stresses to achieve a free-flowing, permanently non-dusting pigment.

Another method for making free-flowing powders with low dust can be obtained by spray drying. These products generally exhibit poor pigmentary properties. Thus, pigment end users have generally had to choose between free-flowing, low dusting, spray-dried pigments with poor pigmentary properties and dusty, milled pigments with poor flow characteristics

U.S. Pat. No.3,660,129 establishes that titanium dioxide pigments are coated with hydrous oxides, then sand-milled and spray-dried to improve flowability.

The stated spray dryer generally results in small particle sizes with a high proportion of fines. This means that a substantial proportion of the material is not realized from the dryer as directly usable pellets, but as fines, which must first be retained in a filter and then returned to the process. In spray dried products, hydrophobic post-treatment results in particles that have somewhat good flow properties but produce exceptionally large quantities of dust.

U.S. Pat. No. (4,810,305) and (U.S. Pat. No. 5,035,748) represent spray pelletization using siloxanes as hydrophobic additives.

U.S. Pat. No. 5,199,986 demonstrates that colored building materials are produced by incorporating into the building materials inorganic pigments in the form of granulates which are free-flowing and not dust forming where the pigments are produced from spray dried granulates by post-granulating

U.S. Pat. No. 5,733,365 and U.S. Pat. No. 5,908,498 illustrate a process for manufacturing titanium dioxide characterized by improved flowability, low dust production, and good dispersibility, without the energy-intensive and expensive step of micronization. In this process, at least one treating agent is deposited on a pigment that has been sand milled, as an aqueous slurry. The treated slurry is then spray dried for end-use performance without jet milling or micronization.

Known production processes for pigment pellets in addition to the spray granulation (spray drying using a disk or jet) are agglomeration pelletization (mixers, fluidized bed pelletizers, plates or pins) or compaction processes.

U.S. Pat. No. 6, 132,505 instructs that inorganic pigment pellets comprising the steps of mixing at least one inorganic pigment powder with at least one water-soluble, hydrophilic or hydrophobic/hydrophilic auxiliary substance liquid in a quantity of 0.1 to 10 wt. %, relative to the pigment powder, and pelletizing the resultant mixture of by compacting and crushing the resultant mixture, one fraction having an average particle size of 100 to 1000 [symbol] m.

U.S. Pat. No. 7,566,497 B2 provides a method and apparatus for agglomerating pigment and powder particles to improve bulk-handling properties, reduce dusting, and improve bulk density. The aforementioned apparatus utilizes scooped paddles for lifting and dispersion of material within the machinery.

None of the aforementioned patents enlighten, teach or even suggest about a process consisting of agglomeration of pigments, utilizing electrostatic charges, natural cohesion with coalescence, agglomeration and deareation within the presence a natural draft air flow, and utilizing perforated panels to obtain a pseudo particle to provide an extremely friable, highly dispersible pigment that is smoothly discharging, alleviating bridging, and rat holing, with reduced dusting, resistant to compaction and easily metered, and more dense and this is the subject of this application.

### DISCLOSURE OF THE INVENTION

It is an objective of this invention to produce free flowing titanium dioxide pigment or other pigments and powders to have smooth dry flow and handling characteristics, resulting in little to no rat holing, bridging, caking or solid compaction during storage.

It is also an objective of this invention to maintain the same dispersibility of the pigment after being stored in a compressed state as it is in the un-agglomerated state before compression. These pseudo-particles can be used for coloring paint, inks, plastics, elastomers, cosmetics or ceramics and other powder materials.

It is an additional objective of this invention to minimize dust from the products. Agglomerates have very little or no dust, flow freely, and have a defined particle shape, higher bulk density, and lower bulk volume. These low-dust, smoothly flowing compositions are particularly suitable for use with metering and feeding devices.

It is yet another objective of this invention to increase the bulk density of the powder or pigment being processed through this unit, thus reducing packaging requirements, by being able to put more into the same size package or utilizing a smaller package, thus providing a cost savings.

In the prior art, as described above, in order to provide free flow or reduced dusting, various complex methods of chemical processes, making composites, or mixtures or treatments are provided. In the present invention, the rotary cylinder agglomerates with its specifically and specially designed perforated panels providing simple, effective processing pelletizing and, with no additional chemicals required, and an effective method to produce a free-flowing higher bulk density, lower dusting and well dispersing pigment. The rotating drum agglomerator as well as the internals are made of 304L stainless steel so as not to contaminate the product. Additionally, the use of polymer components is acceptable for use under certain applications.

The present invention implements a rotary cylinder whose internals have been specifically designed for the continuous agglomeration, densification and production of smoothly discharging, easily metered low dusting pigment compositions with good dispersibility even after long term compacted storage or aging (an effect of the environment and especially occurs as TiO2 pigment is exposed to high humidity and high temperature).

The type of particle movement required to mix dry powders can create ideal conditions for particle size enlargement is agglomeration. Agglomeration can be defined as a process of particle size enlargement in which small, fine particles, such as dusts or powders, are gathered into clusters, pellets, or particles for use as end products. This present processing unit is comprised of agglomerating the powdered titanium dioxide pigment with or without a seed pigment for a time sufficient in the presence of small natural draft airflow and electrostatic charges also utilizing Van der Waal forces for substantially all of the TiO2 pigment to be agglomerated into extremely friable spherical ersatz particles and is utilized to overcome dusting, poor dry flow, low bulk density, and aging as well. TiO2 tends to form into large clumps or chunks over time and there can be loss of optical properties of said titanium pigment when incorporated into paints, coatings, and plastics applications. Temperatures used range from ambient to 100 deg C.

Benefits of this new method of agglomeration are:
1. Increased bulk density-decreases packaging size and requirements
2. Improved flowability-reduced lumping/caking and control of flow rate
3. Dedusting-Safety and aesthetics of finished product and also minimal dust
4. Produce specific size and shape-composition uniformity, consistent product performance.
5. Greatly reduced sound levels, ˜20 dbA, to a significantly lower level than that required by Occupational Health and Safety Administration, time weighted 8 hour average for hearing protection.
6. Ability to provide custom sizes of pseudo particles.

Tumble growth or “snowballing” is one the mechanism of this agglomeration. In tumble growth agglomeration, small particles move irregularly, and randomly collide in a material bed, which causes them to adhere to each other, in this case from electrostatic charges and van der Waal forces exhibited by the minute particles, especially when the particle size is less than 1 micron. They form a new entity that is held together by electrical binding forces without the use of liquids or other chemical binders.

The rotating cylinder singular inlet passageway has a bore containing the pigment or powder which is then elevated by perforated paddles, and moved off of and then descends through the atmosphere.

This causes another mechanism of this specifically designed unit and it is the ability to continuously cascade and coalesce. This specially designed rotating drum agglomerator provides a specially designed lifting apparatus to promote the stochastic movement of particles descending inside the vessel to accomplish this phase of agglomeration. An old basic principle was to spray binder onto a falling curtain of material. In this case, the pigments in this invention rely on no liquid binders. The lifting device of planar design, is fabricated with a propriety aperture pattern to enhance distribution at point of departure before the pigment or powder descends and is installed on the interior chamber of the rotating cylinder in an axial helix to provide, while rotating axially, a continuous uniform falling curtain of titanium dioxide (or other powders), thus imparting an additional electrostatic charge from stripping electrons from the medium (generally air) through which it moves, similar to rain falling through the atmosphere, thereby enhancing the already present natural electrostatic charges existing in the titanium dioxide or other cohesive powders. This stability is brought about by using the high cohesive forces within the individual particle to an advantage rather than a disadvantage. The agglomerates' structure also depends on several other factors, including the amount of deareation affecting the material bed's density, the height imparted to the avalanching bed, the binding mechanism, and the processing time. The high-density material bed, which has been deareated such as in this specially designed drum agglomerator, produces a denser, less porous agglomerate because particles that have attached themselves to the agglomerate surface and are either torn off again or moved to another location on the surface in the contact section of the process. Once these entities, or nuclei are formed, then they continue to grow as additional particles become attached again to the surfaces, thus continuing to form agglomerates.

The rotating drum is set on an incline. This incline angle can be varied to either enhance conveyance through the cylinder or increase retention time in the cylinder.

The invention is not only particularly effective with titanium dioxide but also as well as other inorganic oxide pigments such as alumina, magnesia, and zirconia. The invention can be practiced on materials less than about one micron in average diameter, and is preferably practiced on pigments and fillers, having average particle sizes of about 0.01 to about 5 microns. The spherical agglomerates produced are preferably at least about 0.01 millimeters in diameter, most preferably from about 0.1 millimeters to about 4 millimeters in diameter.

This unit is specifically designed and optimized for the continuous processing of titanium dioxide pigments and other pigments to include but not limited to white opacifying pigments such as, basic carbonate white lead, basic sulfate white lead, basic silicate white lead, zinc sulfide, zinc oxide, composite pigments of zinc sulfide and barium sulfate, antimony oxide and the like, white extender pigments such as calcium carbonate, calcium sulfate, china and kaolin clays, mica, diatomaceous earth and colored pigments such as iron oxide, lead oxide, cadmium sulfide, cadmium selenide, lead chromate, zinc chromate, nickel titanate, chromium oxide, and the like. Of all the pigments useful in producing the improved pigments of the present invention, the most preferred pigment is titanium dioxide.

Titanium dioxide that can undergo the described process to provide the improved pigments of the present invention include any of the white or colored, opacifying or non-opacifying particulate pigments (or mineral pigments) known and employed in the surface coatings (e.g., paint) and plastics industries. For purposes of this present detailed description, the term pigments is used broadly to describe materials which are particulate by nature and nonvolatile in use and typically are most usually referred to as inerts, fillers, extenders, reinforcing pigments and the like and are preferably inorganic pigments.

Titanium dioxide pigment employed in the process of this invention can be either the anatase or rutile crystalline structure or a combination thereof. The pigment may be produced by known commercial processes which are familiar to those of skill in this art but which those processes do not form any part of the present invention. Either the well-known sulfate process or the well-known vapor phase oxidation of titanium tetrachloride process can produce the specific pigment.

Titanium dioxide particles in the present invention, this specially designed rotary drum agglomerator, are particularly useful because the pigment is extremely cohesive in all aspects due to the high electrostatic charges, the bipolar nature of the particle and the high van der Wahl forces that are inherently present from the extremely small particle size. These titanium pigments include anatase and rutile crystalline forms and may be treated or coated, e.g., with one or more oxides or hydroxides of metals including aluminum, antimony, beryllium, cerium, hafnium, lead, magnesium, niobium, silicon, tantalum, titanium, tin, zinc, or zirconium. The pigments of titania or other inorganic oxides can contain aluminum, introduced by any suitable method, including the co-oxidation of halides of titanium, (or other metal) and aluminum as in the “chloride process” or the addition of aluminum compounds before calcination in the “sulphate process”.

Other products, but not all inclusive, that can be manufactured as specified in this invention, to improve the properties include fly ash, powdered foodstuffs, cement, cosmetics, polytetrafluoroethylene, powders, talc and clay.

According to one aspect of the present invention, a smoothly discharging pigment consists of spherical pseudo particles; the pigment is 91% by weight or more pigment and may be to the extent of 99.9% by weight. Also present, but not significantly, are one or more surface treatments that are standard on some pigments.

These pseudo-particles can be used for the pigmentation of aqueous or non-aqueous systems where requirements are low dust, good material flow, and accurate metering or feeding properties.

### EXAMPLE 1

100 parts by weight of finely ground, red iron oxide pigment is mixed with the seed pigment of the same with 0.5 to 1.5 parts by total weight of propylene glycol. The mixture is placed in a specialized mixing vessel and blended. The process is continued and within about 0.10-15 minutes complete pseudo-particle formation occurs, and a smoothly discharging product is obtained.

Increase in bulk density of the processed pigment is nominally 36%

Angle of repose decreased from 55.6 deg to 41.6 deg, a decrease of 25% .

Increase in flow rate of the processed powder was from 100 gms. in 129 seconds to 100 gms. in 20 seconds.

48-hour compression test of between 4 and 6 psi yielded a completely crumbled pigment discharge upon ejection from the forming cylinder. The unprocessed pigment was a hard singular mass that did not even fracture upon ejection.

Decrease in available dust nominally 60%.

### EXAMPLE 2

100 parts by weight of finely ground, black iron oxide pigment is mixed with the seed pigment of the same with 0.5 to 1 parts by total weight of polydimethylsiloxane, 320cs. The mixture is blended in a mixing vessel of specialized design. The process is continued and within about 0.25-15 minutes, pseudo particle formation is complete, and a smoothly discharging product is obtained.

Increase in bulk density of the processed pigment is nominally 29%

Angle of repose decreased from 55.6 deg to 38 deg, a decrease of 32%.

Increase in flow rate of the processed powder was from 100 gms in 129 seconds to 100 gms. in 20 seconds.

48-hour compression test of between 4 and 6 psi yielded a completely crumbled, pigment discharge upon ejection from the forming cylinder. The unprocessed pigment was a hard singular mass that did not even fracture upon ejection.

Decrease in available dust nominally 55%.

### EXAMPLE 3

100 parts by weight of a commercial paint grade rutile titanium dioxide is amalgamated in a vessel of special design for agglomeration. The process is continued and within about .25-15 minutes pseudo particle formation is complete, and a smoothly discharging product is obtained.

Increase in bulk density of the processed pigment is nominally 15%

Angle of repose decreased from 52. Deg to 38.6 deg, a decrease of ˜26%.

Increase in flow rate of the processed pigment was from 50 gms at 1.6 gm/sec seconds to 50 gms at 6.2 gm/sec seconds.

48-hour compression test of between 4 and 5 psi yielded a completely crumbled, pigment discharge upon ejection from the forming cylinder. The unprocessed pigment was a hard singular mass that did not even fracture upon ejection.

Decrease in available dust nominally 70%.

Paint Dispersion comparisons on the Hegman scale are consistent with the unprocessed code standard pigment.

### EXAMPLE 4

100 parts by weight of a hydrophobic plastics grade rutile titanium dioxide, at temperature, is blended in a specialized mixing vessel. The process is continued and within about 0.1-15 minutes pseudo particle formation is complete, and a smoothly discharging product is obtained.

Increase in bulk density of the processed pigment is nominally 16%

Angle of repose decreased from 50.5 deg to 38.3 deg, a decrease of ˜27%.

Increase in flow rate of the processed pigment was from 50 gms at 1.9 gm/sec to 50 gms. at 8.3 gm/sec seconds.

48-hour compression test of between 4 and 5 psi yielded a completely crumbled, pigment discharge upon ejection from the forming cylinder. The unprocessed pigment was a hard singular mass that did not fracture upon ejection.

Decrease in available dust nominally 80%.

Dispersion comparisons through a Brabender Extruder and into a polymer film are consistent with the unprocessed code standard pigment.

In all cases, dust values are assessed as a weight in comparison with the powder. The subjective visual observation of dust on transfer between containers is also used by way of comparison. In all cases, flow is determined by measuring the drain time in seconds from a cylindrical vessel (volume 50 or 100 gm) with a 60 deg. conical base through a defined bore (generally 10 mm).

The dust characteristics of a powder or pellet may be measured using a Heubach “Dustmeter”. The fine dust discharged from a rotating drum, though which an air stream flows at a defined rate, is determined gravimetrically on a glass fiber filter. By making measurements after differing exposure times, the dust generation profile may be plotted as a function of mechanical loading. The dust values are assessed as a weight in comparison with the powder. The subjective visual observation of dust on transfer between containers is also used by way of comparison.

### BRIEF DESCRIPTION OF THE DRAWINGS

A preferred embodiment of the invention will be described hereinafter with reference to the accompanying drawings, in which:

FIG. 1 is a flow diagram of the process of the invention.

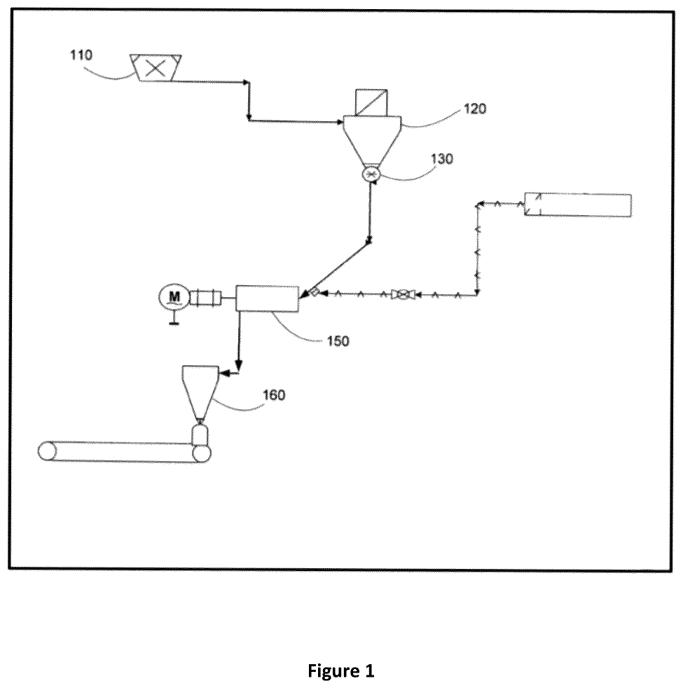

FIG. 2 is a horizontal cross-sectional view of the machine.

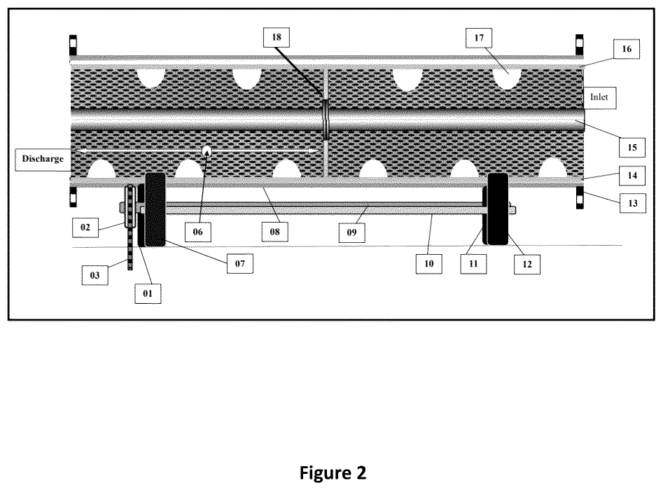

FIG. 3 is a view of the relevant portion (without the feed cone) with the panels and an expanded view.

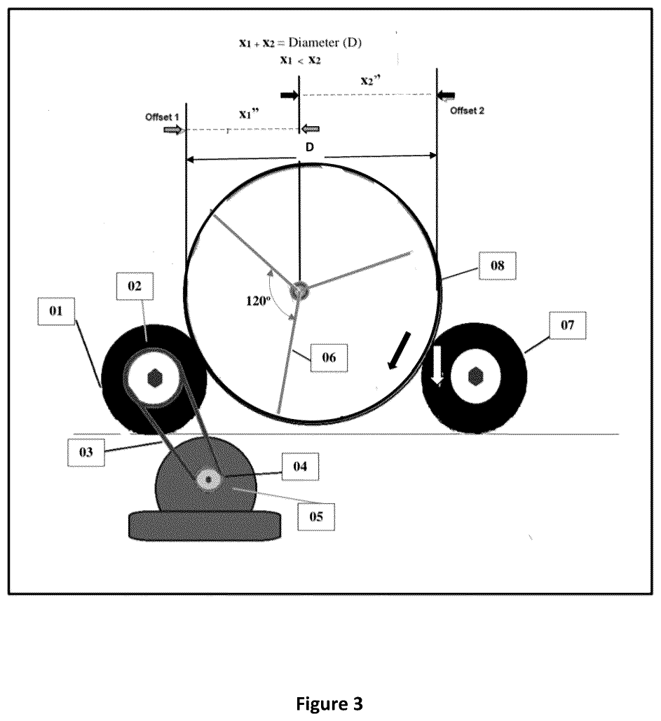

### REFERENCE NUMERALS IN THE DRAWINGS

1. Discharge Elastomeric Drive Wheel
2. Drive Shaft Sprocket
3. Drive Chain or Toothed Belt
4. Driver Sprocket
5. Drive Motor/Base
6. Stainless Steel Processing Sweeps/Perforated Panels
7. Discharge-Conductive Idler Wheel
8. Stainless Steel Shell
9. Drive Wheels Shaft
10. Idler Wheels Shaft
11. Inlet Elastomeric Drive Wheel
12. Inlet-Conductive Idler Wheel
13. Stainless Steel Assembly Flange
14. Stainless Steel Wiper Blade
15. Panel Support Tube
16. Panel Blending Aperture
17. Panel Support Shaft Bumpers

### DETAILED DESCRIPTION OF THE PREFERED EMBODIMENTS

The described process is necessary to understand the inventive product, which insofar as the inventor is aware, may only be made by this process. Clearly the most important feature of a successful free flow pigment is that it has greatly reduced cohesiveness to itself.

As is known, virtually all titanium dioxide pigments have detrimental clumping properties due to the high cohesive nature of the pigment and pack together tightly clumping and caking, during movement in transit, in storage, and in use, forming fine powders or dusts which spread in the air, and which further stick the surrounding areas. Any reduction in dust has serious beneficial implications for National Institute of Occupational Safety and Health, OSHA and health benefits in general.

Typical processing of pigments to form agglomerates usually require other chemicals to bind the pigments together, thus forming a mixture of chemicals forming a composite and not solely pigment. When processed into composite with various mixers, the hard particle count is considerably higher, and the ability to disperse is reduced.

The pigment, inventive process and inventive equipment and inventive perforated panels form a homogeneous agglomerated pigment with substantially round smooth particles having a higher bulk density than prior art and has significantly reduced dust generation with high free flow and maintains the original dispersibility. The round shape is proven to substantially increase the flowability and reduce or eliminate the generation of powder fines or dusts in processing and resists compaction, clumping and ageing in storage and shipment. The pseudo particles after forming have little adhesion to one another, primarily due to their round shape and the utilization of van der Wahl forces within those pseudo particles, and the self-attraction of the electrostatic forces induced by the actions caused by the perforated panels beforehand. Thus, when the pseudo particles arrive at their final size, they do not attract other large particles. Nevertheless, the pseudo particles retain the beneficial characteristics of extremely high friability and good dispersion because they are not mechanically or chemically bound together. The increased density also means that the pigment from the inventive process and equipment, on an equal weight basis, utilizes less volume, and less packaging, while the customer receives an even further benefit for he does not require as much warehouse space for storage.

The titanium dioxide pigment is provided in a powder from the standard Grinding Equipment (110), known in the art as finished pigment, and is in a powder form to Feed Bin (120) and fed from the Feed Bin (120) through a rotary valve (130), which maintains the desired feed rate, then the pigment is deareated vibrationally, when being fed into the inventive equipment, the Rotary Drum Agglomerator (150). After processing through the Rotary Cylinder (150), the titanium dioxide pigment is then conveyed to the Packing Bin (160).

The Rotary Drum Agglomerator (150) is driven by a variable speed drive gear box and power is transmitted through the drive chain (3), and drive sprocket (2), promoting the shell segment (8) to rotate. The Rotary Drum Agglomerator (150) is supported by frame and wheels (1),(7),(11), and (12) for ease of rotary movement. Internally, the perforated panels (6) mechanically lift, dispenses, cause nucleation from van der Wahl forces, cause coalescence from electrostatic charges, control cascade and consolidate the pigment, while the shell segment (8) avalanche, slide and layer or “snowball” the pigment to form a uniformly spherical product, in which then the titanium dioxide pigment or other pigments or powders without any compression of the pigment, is formed in to round smooth pseudo particles. Finished titanium dioxide or other pigment or powder is fed into the Rotary Drum Agglomerator (150) though an inlet nozzle and encouraged forward by an inlet cone and the incline of the machine reducing possibility of back up. Pigment build up on the walls is eliminated and further densification is accomplished by the tilting movement of the perforated panels (6) and impact with the cylinder wall (8) imparting vibrational energy to cause any incipient build up to fall off, and causatively vibrate entrained air from the dry pigment.

The Rotary Drum Agglomerator (150) has been discovered by the inventor to form smooth round highly friable particles of pigment but does not compress the pigment. Thus, the resulting pseudo particles have a bulk density as high as 20% greater than that of unprocessed pigment.

The output from the Rotary Drum Agglomerator (150) from discharge ports is in the form of round pseudo particles of varying sizes. The resulting product is nearly between +12 to +100 mesh size round smooth bead of no hardness. The resulting pigment is a perceptible small bead, visually similar in comparison to table salt, or granulated sugar.

The result of the invention is thus a novel physical form of pigment, and a novel process of producing the inventive titanium dioxide pseudo particle. The resulting pigment is denser than all other unprocessed titanium dioxide pigments, freer flowing, and substantially dust free in use, while it resists the undesirable clumping and ageing properties of unprocessed pigments. It should be understood that the embodiments described herein are exemplary and that a person skilled in the art may make many variations and modifications without departing from the spirit and scope of the invention as defined in the appended claims. The invention therefore extends to those physical equivalents of the claimed process and equipment for the pigment.

We claim:

1. A processing and equipment for the production of a free-flowing and relatively dust-free titanium dioxide, other pigments and powders which adhere intimately together to form substantially spherical agglomerates or psuedo-particles ranging in size from 0.1 mm up to 5.0 mm in diameter where by the pigment is blended in a specially designed rotating cylindrical vessel with the presence of an induced electrostatic charge and an air flow and specially designed lifter consisting of perforated panels for elevating and distributing the pigment to coalesce and cohere.

2. The processing and equipment according to claim 1 wherein intimate blending and mixing is carried out at a temperature within the range from 0 deg C to 100 deg. C.

3. The processing and equipment of claim 1 wherein nucleation and layering are carried out for a time of from about 0.25 minutes to about 15 minutes.

4. The processing and equipment according to claim 1, may include post treating the inorganic pigments or powders.

5. The processing and equipment according to claim 1, wherein the post treating step may or may not comprise application of alcohols, esters, silicone compounds, glycols, polyols, or polyethers, in a quantity of 0.01 to 3 wt. %, relative to pigment pellets.

6. A low-dusting, free-flowing, titanium dioxide or other pigment or powder produced by the processing and equipment of claim 1 which is as dispersible as the original pigment.

7. The spherical agglomerates of any of claim 1 wherein said metal oxide material is titanium dioxide pigment or other inorganic pigment.

8. The spherical agglomerates of any of claim 1 wherein said metal oxide material contains a metal oxide pigment.

9. The process of claim 1 wherein a metal oxide coating on the pigment may be present in an amount of from about 0 percent to about 1.5 percent by weight.

10. The spherical agglomerates of claim 1 wherein said titanium dioxide or other metal oxide pigment may be coated with none or at least one metal oxide and can contain an oxide or hydroxide of aluminum, silicon, or zirconium.

11. A specially designed perforated panel of the processing and equipment is used to carry said titanium dioxide or other pigments to continuous produce as free flowing particles while transporting beyond the pigments apparent angle of repose.

12. The processing is electrically isolated to prevent electrostatic discharge.

13. The generated electrostatic charges, van der Waal forces, in addition to any inherent electrostatic charges, cause self-attraction whereby nucleation takes effect.
